(19) United States
(12) Patent Application Publication
(10) Pub. No.: US 2021/0056777 A1
(43) Pub. Date: Feb. 25, 2021

(54) SYSTEM COUPLED TO VEHICULAR COMPUTING DEVICES AND SENSORS FOR MONITORING AND VERIFYING USAGE OF THE ASSOCIATED VEHICLE

(71) Applicants: Joshua Brian Glickman, Washington, DC (US); Lisa Gogolinksi, Surprise, AZ (US)

(72) Inventors: Joshua Brian Glickman, Washington, DC (US); Lisa Gogolinksi, Surprise, AZ (US)

(21) Appl. No.: 16/545,507

(22) Filed: Aug. 20, 2019

(51) Int. Cl. G07C 5/02; G07C 5/08

(52) U.S. Cl. CPC G07C 5/02; B60T 7/00; G07C 5/0816

(57) ABSTRACT

A vehicular verification system is provided. The vehicular verification system couplable to the computer and sensors of a vehicle for monitoring and verifiable reporting events associated with the history and driving conditions of the vehicle. The vehicular verification system is programmable to establish thresholds for a plurality of such vehicular events, wherein for each vehicular event the vehicular verification system monitors related hardware components and sensors for values in excess of the associated threshold. The vehicular verification system is adapted to produce a usage report of all values in excess of the associated threshold for verifiably ascertaining the history and driving conditions of the vehicle.

### BACKGROUND OF THE INVENTION

The present invention relates to vehicular technologies and, more particularly, to a computer system that communicates with a car's computer and sensors to monitor usage and produce a verifiable report.

Used car consumers have limited options when verifying information in used car advertisements, and unfortunately many used car sellers misrepresent information in such ads. Here are some examples of dubious and difficult to verify representations: “mostly highway miles”, “never seen snow”, “adult-driven”, “never been raced”, “only driven to church every Sunday”, and “California car”, to name a few.

Current verification devices and approaches include odometers, Carfax®, and telematics, since appearance alone is not a practical indicator of a car's history and driving conditions. Odometers, however, only show how many miles the car was driven and nothing more. Similarly, Carfax® provides limited information as it only provides information related to reported accidents and services. Telematics captures information related to safety, but doesn't capture other mechanical data, for example: if the car overheated or experienced RPM-related issues, whether in fact the car was driven in the snow, what percentage of the miles are “highway miles”, and the like.

As can be seen, there is a need for a vehicular verification system that communicates with a car's computer and sensors to monitor usage and produce verifiable reports. The present invention, colloquially known as “TrUsage”, is adapted to capture relevant data to support such a detailed usage report. The present invention generates a verifiable usage report through coupling to a vehicle's computer and sensors for capturing and retrievably storing real-time data, thereby proving or disproving information in used car ads and representation by those selling used cars.

Related vehicular technologies such as but not limited to telematics are inherently computer-based, and thus the computer-implemented method and system embodied by the present invention advances such technologies in a non-abstract manner.

### SUMMARY OF THE INVENTION

In one aspect of the present invention, a vehicular verification system includes but is not limited to the following: a vehicle having a plurality of hardware components electrically connected by way of at least one sensor to a computer; a programmable vehicular verification system couplable to said computer, the vehicular verification system adapted to associate each sensor with one or more event types; the vehicular verification system is adapted to selectively establish a value threshold for each event type; repeatedly checking a sensed value of each sensor against the value threshold so that exceeding said value threshold is retrievably stored as a threshold event. The vehicular verification system adapted to generate a report of each event type and associated sensed value, value threshold, and threshold event. In certain embodiments, threshold events are defined by comparing the sensed value against an immediately previous sensed value. Additional hardware components can be configured—for example GPS.

The plurality of each event type includes but is not limited to the following: an engine speed of an engine of the vehicle increasing or decreasing by 1000 rpms; an airbag deployment of the airbags of the vehicle; a toggling of windshield wipers of the vehicle; a brake pressure of brakes of the vehicle increasing or decreasing by 10 psi; an overheating of the engine of the vehicle; a percentage of the throttle of the vehicle increasing by 25%; an oil pressure of the vehicle increasing or decreasing by 5 psi; a gear change of a plurality of gears of the vehicle; a start of an engine of the vehicle; and an engagement of an anti-lock braking system of the vehicle. Additional event types can be configured and associated with new hardware types—for example GPS location change from one state to another.

The database will periodically be backed up to the cloud, securely, to prevent tampering with the event history.

In another aspect of the present invention, the vehicular verification system includes but is not limited to the following: vehicle having a plurality of hardware components; a computer; each hardware component electrically connected to the computer by way of at least one sensor; a programmable vehicular verification system couplable to said computer, the vehicular verification system adapted to: associate each sensor with one or more event types; selectively establish a value threshold for each event type; repeatedly compare a sensed value of each sensor against the respective value threshold; on-demand generation of a report of each event type comprising a threshold event each time the sense value exceeds the respective value threshold; one or more databases coupled to the vehicular verification system for retrievably storing each event type and associated sensed values, associated threshold values and associated threshold events.

These and other features, aspects and advantages of the present invention will become better understood with reference to the following drawings, description and claims.

### BRIEF DESCRIPTION OF THE DRAWINGS

FIG. 1 is an architectural diagram of an exemplary embodiment of the present invention;

FIG. 2 is a class diagram of an exemplary embodiment of the present invention;

FIG. 3 is an ERD diagram of an exemplary embodiment of the present invention;

FIG. 4 is a sequence diagram of an exemplary embodiment of the present invention; and

FIGS. 5A-5C is an example of a human readable report/output of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicular verification system couplable to the computer and sensors of a vehicle for monitoring verifiable reporting event types associated with the history and driving conditions of the vehicle. The vehicular verification system is programmable to establish thresholds for a plurality of such vehicular event types, wherein for each vehicular event type the vehicular verification system monitors related hardware components and/or sensors for values with respect to the associated thresholds and in some cases there are multiple thresholds for example speed increase from less than 10 mph to 10 mph is an event and speed increase from less than 15 mph to greater than 15 mph is an event. The vehicular verification system is adapted to produce a usage report of all values regarding the associated thresholds for verifiably ascertaining the history and driving conditions of the vehicle.

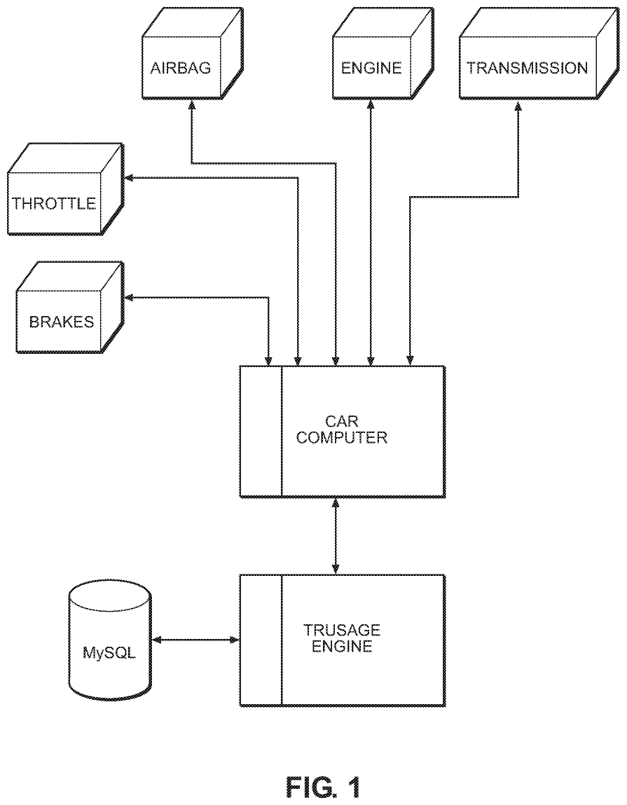

Referring to FIG. 1, the present invention may include a vehicular verification system having at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The vehicular verification system may include inputs (hardware components), logic, one or more coupled databases, and report output functionality. For example, when the gas pedal is depressed more than a certain amount (the threshold) the program will insert a record into a relevant database, such as an event-history database. The event-history database is adapted to produce an event-history table containing a list of all the event types with their corresponding thresholds and associated input data.

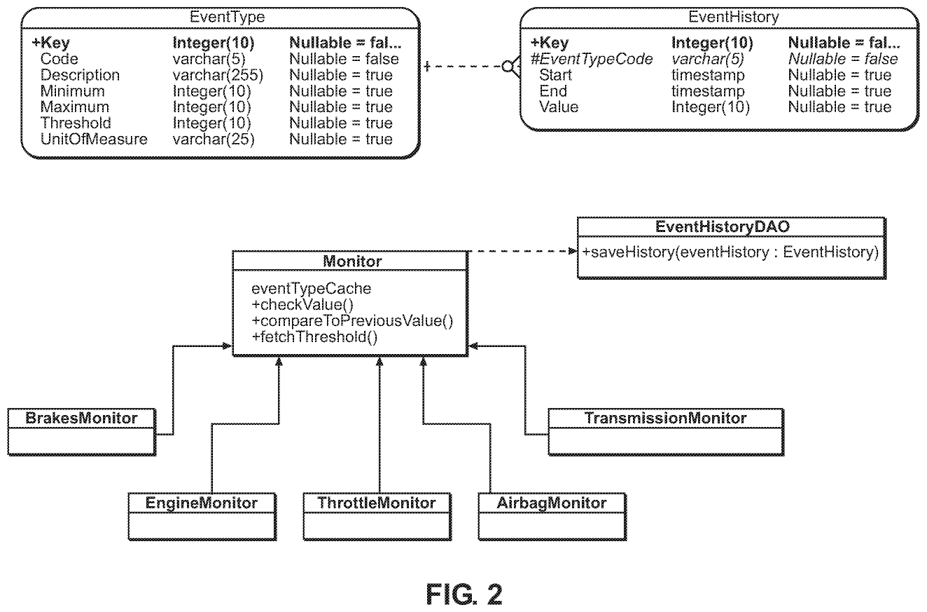

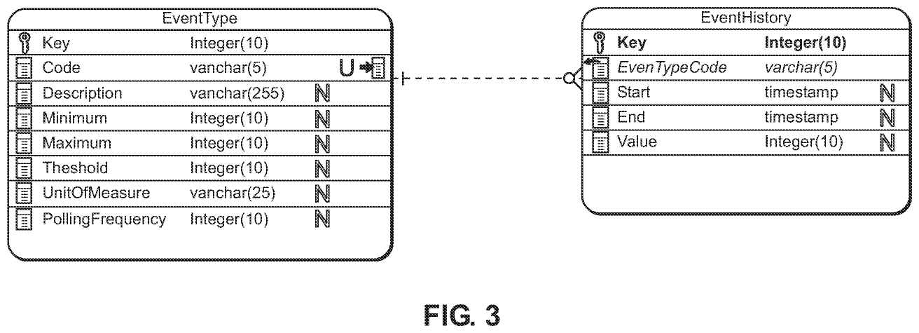

Referring to FIGS. 2 and 3, examples of event types and associated thresholds may include the following table:

| Event types key description | Threshold | Unit of Measure |
|---|---|---|
| Engine Speed | 1000 | RPM |
| Airbags deployed | TRUE | Deployed |
| Windshield wipers | Toggled | Minutes |
| Brake pressure | 5 | PSI |
| Overheat | 130 | Degrees |
| Throttle usage | 25 | % to the floor |
| Low oil pressure | 5 | PSI |
| Gear changes | 1 | Gear |
| Start engine | 1 | Occurrence |
| Stop engine | 1 | Occurrence |
| Roadside assistance | 1 | Occurrence |
| Speed | 5 | MPH |
| ABS engaged | 1 | Occurrence |
| Bucking | TRUE/FALSE | |

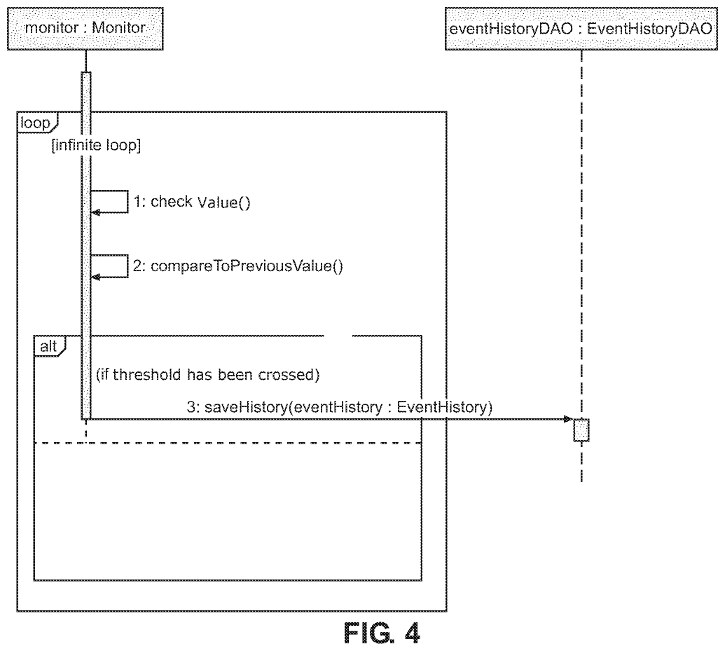

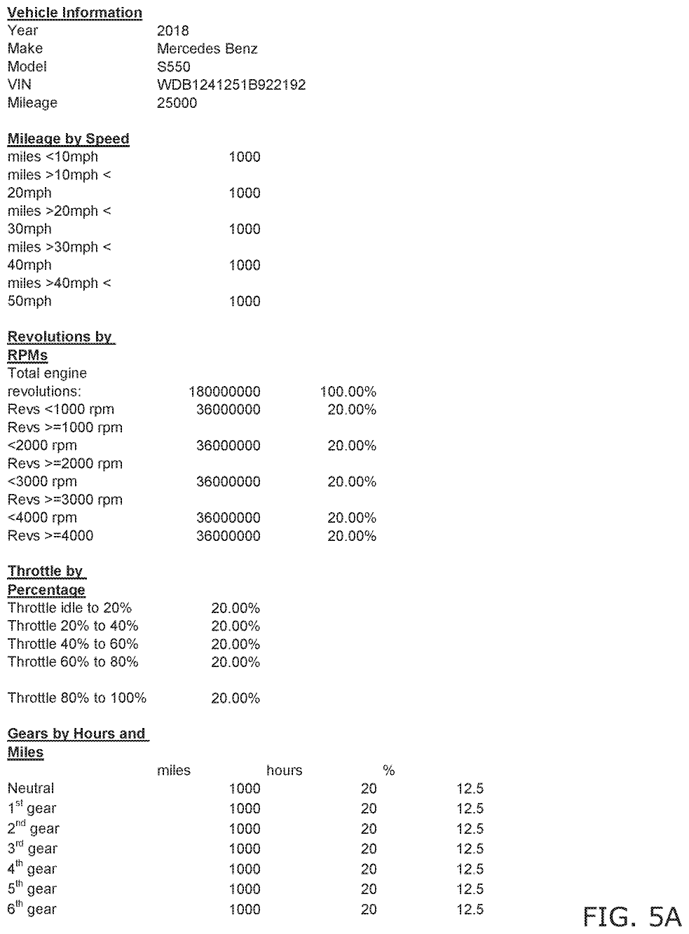

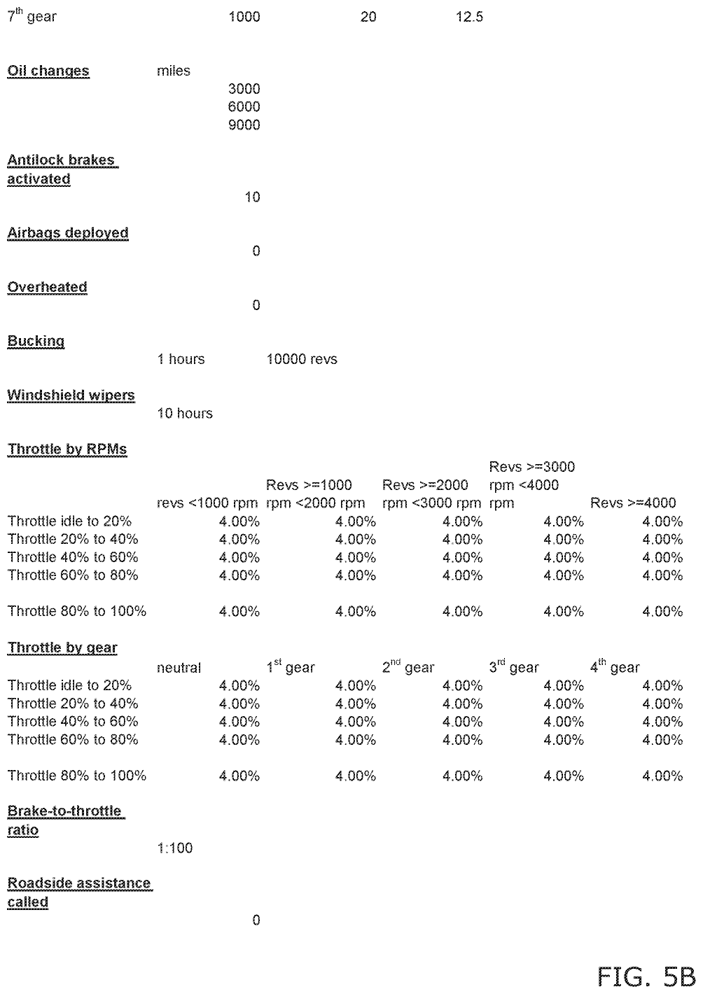

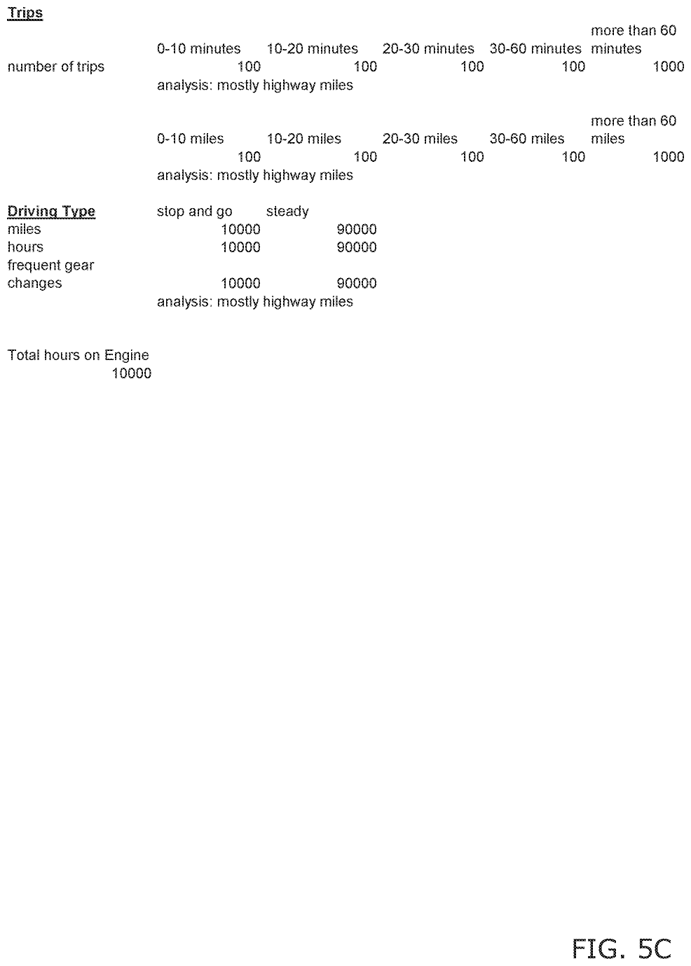

FIGS. 2 and 3 represent exemplary reports that can be generated by the vehicular verification system through incorporating the above event type data, which may be structured according to the ERD diagram of FIG. 3 and the reporting logic. The class diagram of FIG. 2 may represent the structure of the logical objects of the program code which executes according to the sequence diagram of FIG. 4, while the architectural diagram of FIG. 1 shows the hardware components accessed by the software according to sequence diagram of FIG. 4. The vehicular verification system data and inputs can be incorporated into a document for marketing.

Referring to FIG. 4, the vehicular verification system may include a programmable threshold for a plurality of values associated with one or more vehicular hardware components. The vehicular verification system provides a main loop adapted to check the sensed values of all the hardware components against the respective programmable threshold value, wherein the present invention is adapted to list each ‘threshold event’ of the programmable threshold value being exceeded into the relevant database and the associated event-history table. In other embodiments, the vehicular verification system compares sensed values against an immediately previous value to determine when to list each threshold event.

The program product may be written in Java, in which case a JRE would be required. MySQL™ database will be used for the database(s). All files may be copied onto a chip which will be placed into the vehicle. The vehicular verification system may be coupled to the car's main computer via a standard interface. A display could be added to view the report from inside the vehicle, but otherwise the report can be exported via email or the like.

A method of using the present invention may include the following. The vehicular verification system disclosed above may be provided. A user-owner of a vehicle coupled to the vehicular verification system may generate the output “TrUsage” report, for instance when selling said vehicle. Likewise, the owner can use this information when composing an advertisement. Additionally, the present invention can also be used for boats and other motor vehicles that have sensors. The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A vehicular verification system, comprising:
a vehicle having a plurality of hardware components;
a computer;
each hardware component electrically connected to the computer by way of at least one sensor;
a programmable vehicular verification system couplable to said computer, the vehicular verification system configured to:
associate each sensor with one or more event types;
selectively establish a value threshold for each event type;
repeatedly compare a sensed value of each sensor against the respective value threshold; and
on-demand generation of a report of each event type comprising a threshold event each time the sensed value exceeds the respective value threshold.

2. The vehicular verification system of claim 1, comprising one or more databases coupled to the vehicular verification system for retrievably storing each event type and associated sensed values, the associated threshold values and the associated threshold events.

3. The vehicular verification system of claim 1, wherein a threshold event is determined by comparing the sensed value against an immediately previous sensed value.

4. The vehicular verification system of claim 1, wherein the one or more event types comprises an engine speed of an engine of the vehicle.

5. The vehicular verification system of claim 1, wherein the one or more event types comprises an airbag deployment speed of an airbag of the vehicle.

6. The vehicular verification system of claim 1, wherein the one or more event types comprises a toggling of windshield wipers of the vehicle.

7. The vehicular verification system of claim 1, wherein the one or more event types comprises a brake pressure of brakes the vehicle.

8. The vehicular verification system of claim 1, wherein the one or more event types comprises an overheating of an engine of the vehicle.

9. The vehicular verification system of claim 1, wherein the one or more event types comprises a usage of a throttle of the vehicle.

10. The vehicular verification system of claim 1, wherein the one or more event types comprises an oil pressure of the vehicle.

11. The vehicular verification system of claim 1, wherein the one or more event types comprises of a gear change of a plurality of gears of the vehicle.

12. The vehicular verification system of claim 1, wherein the one or more event types comprises of a start of an engine of the vehicle.

13. The vehicular verification system of claim 1, wherein the one or more event types comprises of an engagement of an anti-lock braking system of the vehicle.

14. A vehicular verification system, comprising:
a vehicle having a plurality of hardware components;
a computer;
each hardware component electrically connected to the computer by way of at least one sensor;
a programmable vehicular verification system couplable to said computer, the vehicular verification system configured to:
associate each sensor with one or more event types;
selectively establish a value threshold for each event type;
repeatedly compare a sensed value of each sensor against the respective value threshold; and
on-demand generation of a report of each event type comprising a threshold event each time the sense value exceeds the respective value threshold;
one or more databases coupled to the vehicular system for retrievably storing each event type and associated sensed values, associated threshold values and associated threshold events,
wherein the one or more event types comprises:
an engine speed of an engine of the vehicle;
an airbag deployment speed of an airbag of the vehicle;
a toggling of windshield wipers of the vehicle;
a brake pressure of brakes the vehicle;
and overheating of the engine of the vehicle;
a usage of a throttle of the vehicle;
an oil pressure of the vehicle;
a gear change of a plurality of gears of the vehicle;
a start of an engine of the vehicle; and
an engagement of an anti-lock braking system of the vehicle.

15. The vehicular verification system of claim 14, wherein the one or more database will be backed up to the cloud periodically to prevent tampering with the threshold events.

16. The vehicular verification system of claim 14, wherein a threshold event is determined by comparing the sensed value against an immediately previous sensed value.
